(19) United States
(12) Patent Application Publication
(10) Pub. No.: US 2017/0262932 A1
(43) Pub. Date: Sep. 14, 2017

(54) SYSTEMS AND METHODS FOR PURCHASING FRESH FOOD ITEMS ONLINE

(71) Applicant: Wal-Mart Stores, Inc., Bentonville, AR (US)

(72) Inventors: Jimmie R. Clark, Fayettteville, AR (US); Ryan Stalder, Rogers, AR (US); Gregory Sieranski, Bentonville, AR (US)

(21) Appl. No.: 15/452,911

(22) Filed: Mar. 8, 2017

Related U.S. Application Data
(60) Provisional application No. 62/305,099, filed on Mar. 8, 2016.

(51) Int. Cl. G06Q 30/06; G06F 17/30

(52) U.S. Cl. CPC G06Q 30/0643; G06F 17/30312; G06Q 30/0633

(57) ABSTRACT

Provided are a retail checkout system and method. A customer record includes registered identification information related to a store customer. An input device receives unique customer identification information from a purchaser card of the store customer. A customer identification analyzer verifies that the received unique customer identification information is included in the registered identification information of the customer record. An order linking module associates purchase data with the unique customer identification information of the purchaser card. A customer record processor updates the customer record to include the purchase data.

### CROSS REFERENCE TO RELATED APPLICATION[S]

This application claims priority to U.S. Provisional Patent Application entitled “SYSTEMS AND METHODS FOR PURCHASING FRESH FOOD ITEMS ONLINE,” Ser. No. 62/305,099, filed Mar. 8, 2016, the disclosure of which is hereby incorporated entirely herein by reference.

### FIELD OF THE INVENTION

The invention relates generally to online shopping, and more specifically, to systems and methods for purchasing fresh food items online.

### BACKGROUND

There are two primary shopping options available to a customer who wishes to purchase a fresh food items. The first includes the physical presence of the customer at a retail establishment, referred to as a “brick-and-mortar” store. Here, the customer can retrieve the fresh food item of interests from in-store inventory if the fresh food items are available, and purchase the fresh food items at a checkout counter at the store. The second shopping option is referred to as “online shopping” where the customer can purchase fresh food items over the internet. Here, the purchased fresh food items may be picked up by the online customer or delivered to a location designated by the online customer.

### BRIEF SUMMARY

In one aspect, provided is a system for online shopping for fresh food products, comprising: a server comprising a memory, a database stored in the memory, and a processor, wherein the database contains data for a plurality of fresh food products; and a computer coupled to the server wherein a user interfaces with the server through the computer, wherein the server is programmed to: display available fresh food products from the data for the plurality of fresh food products on the computer coupled to the server; receive from the computer a signal indicating selection of one of the available fresh food products; automatically create and display a set of user selectable characteristics related to the selected fresh food product; receive from the computer a signal indicating selection of characteristics related to the selected fresh food product; automatically store the selected characteristics related to the selected fresh food product in the database associating the characteristics with the particular user and the selected fresh food product; automatically convert the selected characteristics related to the selected fresh food product to a selection scale and store the selection scale in the database associated with the particular user and the selected fresh food product; and provide the selection scale for the particular user and the selected fresh food product for order filling.

In another aspect, provided is a method for shopping for fresh food products, comprising: storing data for a plurality of fresh food products in a database of a server comprising a memory and a processor, wherein the database stored in the memory; coupling the server to a computer wherein a user interfaces with the server through the computer; displaying available fresh food products from the data for the plurality of fresh food products on the computer coupled to the server; receiving at the server from the computer a signal indicating selection of one of the available fresh food products; automatically creating at the server and display at the computer a set of user selectable characteristics related to the selected fresh food product; receiving at the server from the computer a signal indicating selection of characteristics related to the selected fresh food product; automatically storing the selected characteristics related to the selected fresh food product in the database associating the characteristics with the particular user and the selected fresh food product; automatically converting by the server the selected characteristics related to the selected fresh food product to a selection scale and storing the selection scale in the database associated with the particular user and the selected fresh food product; and providing the selection scale from the server for the particular user and the selected fresh food product for order filling.

In another aspect, provided is a system for online shopping for items, comprising: a server comprising a memory, a database stored in the memory, and a processor, wherein the database contains data for a plurality of items for sale; and a computer coupled to the server wherein a user interfaces with the server through the computer, wherein the server is programmed to: display available items from the data for the plurality of items for sale on the computer coupled to the server; receive from the computer a signal indicating selection of one of the available items; automatically create and display a set of user selectable characteristics related to the selected item; receive from the computer a signal indicating selection of characteristics related to the selected item; automatically store the selected characteristics related to the selected item in the database associating the characteristics with the particular user and the selected item; automatically convert the selected characteristics related to the selected item to a selection scale and store the selection scale in the database associated with the particular user and the selected item; provide the selection scale for the particular user and the selected item for order filling; automatically retrieve and display selected characteristics related to the user and the selected item in response to the user accessing the system again through the computer; automatically display available modifications to the selected characteristics related to the user and the selected items; receive from the computer a signal indicating selection of modification to the selected characteristics related to the selected item; automatically store the modified selected characteristics related to the selected item in the database associating the characteristics with the particular user and the selected item; automatically convert the modified selected characteristics related to the selected item to a modified selection scale, wherein the modified selection scale is different from the selection scale; and store the modified selection scale in the database associated with the particular user and the selected item.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of a system for online shopping for fresh food products, in accordance with some embodiments.

FIG. 2 is a flow diagram illustrating a method for online shopping for fresh food products, in accordance with some embodiments.

FIG. 3 is a flow diagram illustrating a method for picking an order for fresh food products a purchaser made online, in accordance with some embodiments.

FIG. 4 is a flow diagram illustrating a method for providing customer feedback, in accordance with some embodiments.

FIG. 5 is a schematic diagram of a system for online shopping for fresh food products and picking of the fresh food products, in accordance with some embodiments.

### DETAILED DESCRIPTION

Many store customers prefer to shop online, while other store customers prefer to be physically present at a brick-and-mortar when shopping, referred to as being offline. These customers enjoy walking about the store, perusing items of interest, etc. Other customers may shop at a store out of necessity since they do not own a home computer or smartphone, or have access to an internet service.

Online customers enjoy a customized and expedient shopping experience that is typically not offered at a brick-and-mortar store. For example, online customers can order items online at any time, thereby avoiding the time-consuming effort of being physically present at the store to select items of interest from shelves and waiting in line at the store checkout to purchase the items especially at peak times. Also, online customers typically have immediate access to their purchase history, and can receive a display of recommended items for purchase based on shopping patterns or other purchase history information.

A customer shopping online may not seek to purchase fresh food items because those items generally include additional care in selecting the fresh food item based on various factors that may be considered regarding the fresh food item. A fresh food item may include produce, vegetables, meats, cheese and/or fresh baked goods. Because an online customer cannot feel, smell, see, listen to or other forms and senses utilized in selecting fresh food items, it is difficult to shop online for fresh food items.

The present inventive concepts provide a system for a customer to order fresh food products online and provide information to accurately pick fresh food items in accordance to the customer's preferences. Accordingly, the customer can use the system to purchase fresh food items online and still provide the input necessary to obtain the fresh food items that are to the customer specifications.

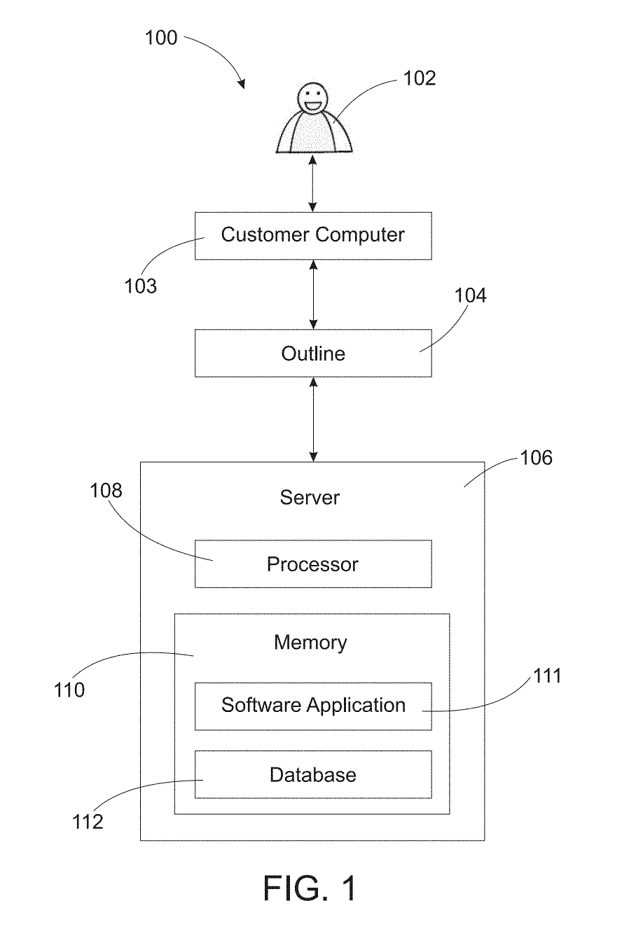

FIG. 1 is a block diagram of a system 100 for online shopping for fresh food products.

The system 100 may include a customer 102, a customer computer 103, an online store 104, and a server 106. The server 106 may include a processor 108 and a memory 110 that includes a database 112. The memory 110 may also include a software application 111, wherein the software application provides programming to the server for performing certain functions in accordance with operation of the present invention. The database 112 may contain data for a plurality of fresh food products or other items for sale. Fresh food product may include, but are not limited to produce, such as fruits and vegetables.

The computer 103 may include a display and may be coupled to the server 106 wherein a user interfaces with the server 106 through the computer 106. This may be accomplished by the computer 103 accessing the server 106 through the online store 104,

The server 106 may be programmed with or otherwise store software application 111 in the memory 110 for the processor to access and interpret the instructions of the program embodied in the software application 111 in order for the server 106 to perform certain functions.

The server 106 may be programmed to display available fresh food products and/or available items for sale from the data for the plurality of fresh food products and/or items for sale on the computer 103 coupled to the server 106. Further, the server 106 may be programmed to receive from the computer 103 a signal indicating selection of one of the available fresh food products and/or items. The selection of one of the available fresh food products and or items may include the customer 102 selecting the fresh food product and/or item from the online store 104. The server 106 may be programmed to automatically create and display a set of user selectable characteristics related to the selected fresh food product or item. The server 106 may be programmed to receive from the computer a signal indicating selection of characteristics related to the selected fresh food product and/or item and automatically store the selected characteristics related to the selected fresh food product and/or item in the database associating the characteristics with the particular user and the selected fresh food product and/or item.

After receiving the selection of characteristics related to the selected fresh food product and/or item, the server 106 may be programmed to automatically convert the selected characteristics related to the selected fresh food product and/or item to a selection scale and store the selection scale in the database associated with the particular user and the selected fresh food product and/or item. The server 106 may then provide the selection scale for the particular user and the selected fresh food product and/or item for order filling.

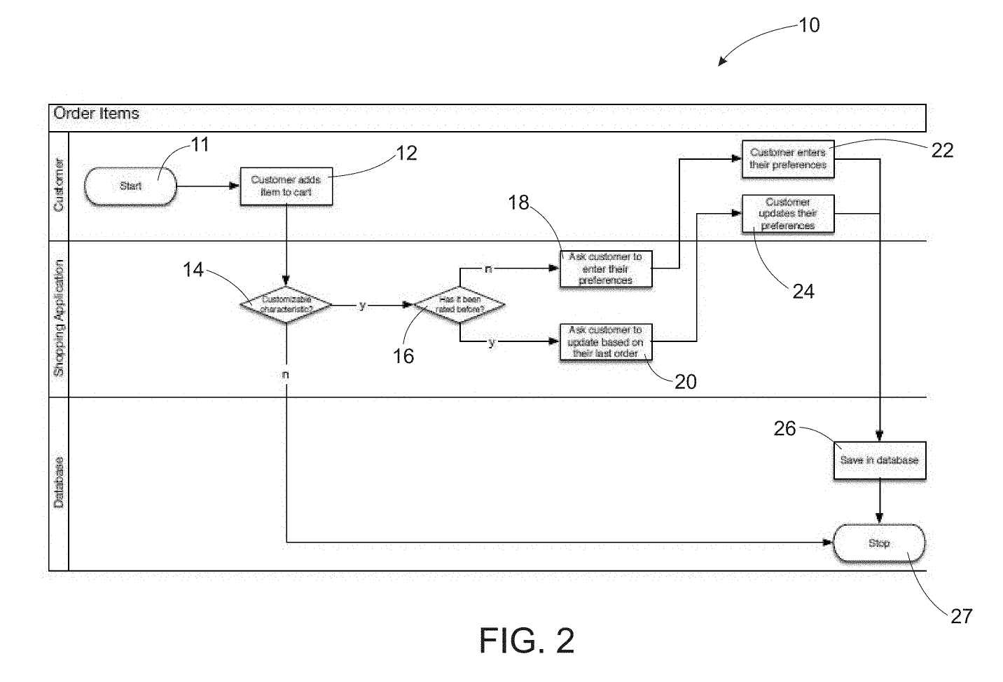

FIG. 2 is flow diagram illustrating a method 10 for online shopping for fresh food products, in accordance with some embodiments. Some or all of the method 10 can be performed utilizing the system 100 illustrated in FIG. 1. Accordingly, in describing the method 10, reference is made to FIG. 1.

The customer 102 shops online for items of interest, including fresh food products utilizing the computer 103. The customer 102 may access the server 106 by accessing the online store 104 associated with the server 106. The method 10 can be initiated at block 11, by the customer 102 accessing the server 106 by using the computer 103 to access the online store 104. The method 10 continues at block 12, wherein the customer 102 adds an item to the online cart. At decision diamond 14, the server 106, operating the software application 111 or shopping application 111, automatically makes a determination whether the item includes customizable characteristics. This is of particular use when the selected item is a fresh food product. If the item does not include customizable characteristics, the method then stops at block 27. If item includes customizable characteristics, the method continues.

If the item includes customizable characteristics, the method 10 includes at decision diamond 16 a decision regarding whether the item has been rated before. If the server 106 determines that it has not been rated before, the method 10 continues to block 18. At block 18 the server 106 presents to the customer 102 through the computer 103 a request to enter the preference of the customer 102 through the computer 103. At block 22 the customer 102 enters his or her preferences regarding that item using the computer 103. The server 106 receives the preferences of the customer 102 from the computer 103 and the server 106 automatically saves the customer preferences in the database 112 as depicted in block 26. After the customer preferences are saved the method stop as shown at block 27. In operation, the system may provide guided questions to allow the customer to input natural preferences or customizable characteristics of the selected item.

If at decision diamond 16 the server 106 determines that the item has been rated before, the method 100 continues to block 20. At block 20 the server 106 presents to the customer 102 through the computer 103 a request to update the preference of the customer 102 through the computer 103. At block 24 the customer 102 enters his or her updates to the preferences regarding that item using the computer 103. This update is generally based on the characteristics of the actual item delivered in a previous order. For example, the customer may be reordering apples and updating the characteristics based on the actual apples delivered to the customer. The server 106 receives the updated preferences of the customer 102 from the computer 103 and the server 106 automatically saves the customer preferences in the database 112 as depicted in block 26. After the customer preferences are saved the method stop as shown at block 27.

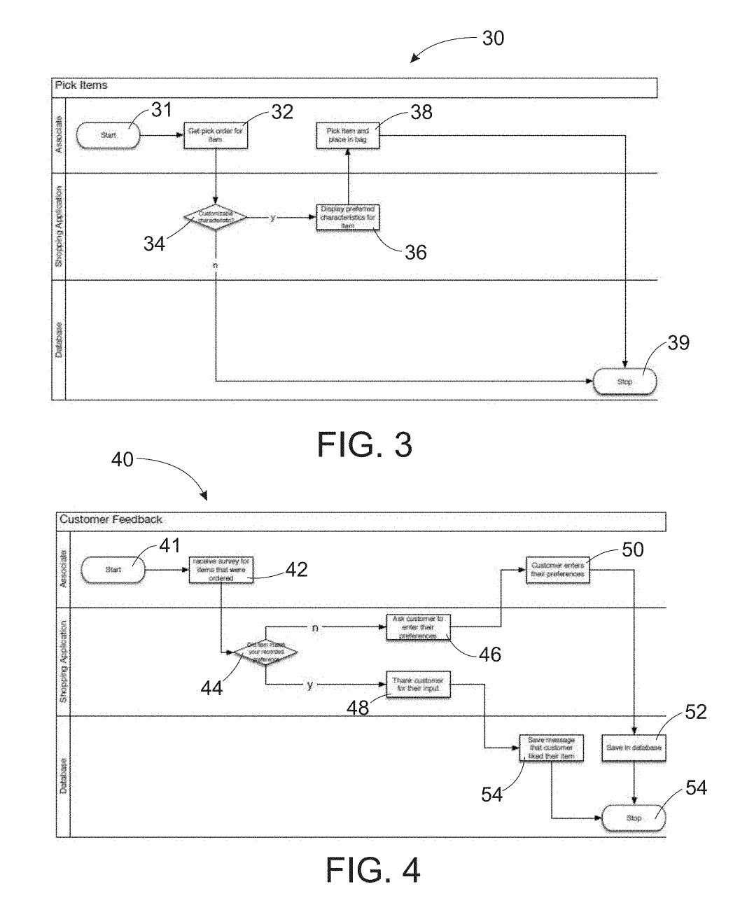

FIG. 3 depicts a flow diagram illustrating a method 30 for picking an order for fresh food products a purchaser made online. Some or all of the method 30 can be performed utilizing the system 100 illustrated in FIG. 1. Accordingly, in describing the method 30, reference is made to FIG. 1.

The method 30 can be initiated at block 31, by an associate accessing the server 106 by using a computer to access the server 106. The method 30 continues at block 32, wherein the associate receives the pick order for the item selected by customer 102 through the system 100. At decision diamond 14, the server 106, operating the software application 111 or shopping application 111, automatically makes a determination whether the item includes customizable characteristics. This is of particular use when the selected item is a fresh food product. If the item does not include customizable characteristics, the method 30 then stops at block 39. If item includes customizable characteristics, the method continues.

If the item includes customizable characteristics, the method 30 includes at block 36 an action to automatically display the preferred characteristics for the item based on the customer input using system 100. At block 38 the associate picks the item in accordance with the preferred characteristics and places the item in a bag. At this point method 30 is completed and is stopped as shown at block 39.

FIG. 4 depicts a flow diagram illustrating a method 40 for providing customer feedback, in accordance with some embodiments. Some or all of the method 40 can be performed utilizing the system 100 illustrated in FIG. 1. Accordingly, in describing the method 40, reference is made to FIG. 1.

The method 40 can be initiated at block 41, by a customer 102 accessing the server 106 by using the computer 103 to access the server 106. The method 40 continues at block 42, wherein the customer 102 receives at the computer 103 from the server 106 a survey for the items that were ordered. At decision diamond 44, the server 106, operating the software application 111 or shopping application 111, presents the customer with a request to indicate whether the item matched the preferences of the customer 102 that he or she entered as the customizable characteristics. This is of particular use when the selected item is a fresh food product. If the customer 102 indicates that the item did match the preferences, the method 40 continues at block 48 to provide a thank you message to the customer 102. Further method 40 continues to block 54, wherein the server 106 automatically saves in the database 112 the indication from the customer 102 that the customer 102 liked and determined that the item matched of the preferences. The method 14 then stops as shown at block 54. If item includes customizable characteristics, the method continues.

If the customer 102 indicates that the item did match the preferences, the method 40 continues at block 46 to request the customer 102 to enter his or her update to the preferences for the item that did not match. Further method 40 continues to block 50, wherein the server 106 automatically displays to the customer 102 on the computer 103 an interface for the customer to enter their preferences or update to the preferences regarding the item. The method then continues to block 52 wherein the server 106 automatically saves in the database 112 the received updated preferences of the customer 102. The method 14 then stops as shown at block 54.

With reference to FIGS. 1-4, a method for shopping for fresh food products may include storing data for a plurality of fresh food products in a database of a server comprising a memory and a processor, wherein the database stored in the memory; coupling the server to a computer wherein a user interfaces with the server through the computer; displaying available fresh food products from the data for the plurality of fresh food products on the computer coupled to the server; receiving at the server from the computer a signal indicating selection of one of the available fresh food products; automatically creating at the server and display at the computer a set of user selectable characteristics related to the selected fresh food product; receiving at the server from the computer a signal indicating selection of characteristics related to the selected fresh food product; automatically storing the selected characteristics related to the selected fresh food product in the database associating the characteristics with the particular user and the selected fresh food product; automatically converting by the server the selected characteristics related to the selected fresh food product to a selection scale and storing the selection scale in the database associated with the particular user and the selected fresh food product; and providing the selection scale from the server for the particular user and the selected fresh food product for order filling.

The method may further include automatically retrieving at the server and displaying at the computer, selected characteristics related to the user and the selected fresh food product; and automatically displaying at the computer available modifications to the selected characteristics related to the user and the selected fresh food product.

Additionally, the method may include receiving from the computer by the server a signal indicating selection of modification to the selected characteristics related to the selected fresh food product; and automatically storing the modified selected characteristics related to the selected fresh food product in the database associating the characteristics with the particular user and the selected fresh food product.

The method may also include automatically converting by the server the modified selected characteristics related to the selected fresh food product to a modified selection scale, wherein the modified selection scale is different from the selection scale, and store the modified selection scale in the database associated with the particular user and the selected fresh food product; and providing the modified selection scale by the server for the particular user and the selected fresh food product for order filling.

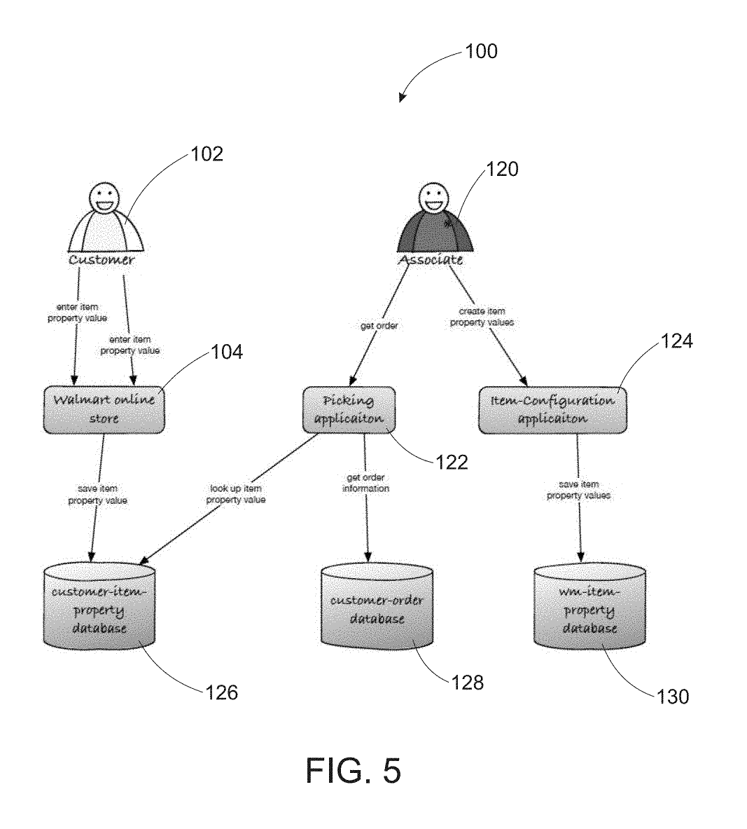

FIG. 5 a schematic diagram of the system 100 for online shopping for fresh food products and picking of the fresh food products, in accordance with some embodiments.

With further references to FIG. 1, the system 100 includes a database 112, wherein the database 112 may a plurality of databases 126, 128 and 130, wherein database 126 is a customer item property database 126, database 128 is a customer order database 128 and database 130 is store item property database.

In system 100, the customer 102 enters preferences for items, such as fresh food products through an online store 104 using a computer 103. The customer may then place an order through the online store by selecting items to add to a virtual cart. The customer's order is stored in the customer order database 128. The server 106 converts the preferences to a selection scale, such as a numerical scale from 1 to 10, a scale of 1 to 4, or even a scale that is photo driven or some other scale factor and stores the selection scale in the store item property database 130. Physical items at the store are sorted by the properties for that item, wherein the properties correspond to the selectable characteristics of the item such as a fresh food product and further may be sorted based on the scale employed.

At the store, an associate 120 will see the customer's order from the customer order database 128. Any items with customer properties will be displayed with the associated scale value through a look up from the customer item property database. The associate 120 may then pack the order and send it to the customer 102.

Once the customer receives the items, the customer 102 may report on the differences between what he or she received and what he or she expected to receive for any items with customer selected characteristics, and the data stored in the customer item characteristic database is adjusted to match a new value in the store item property database based on the changes in the customer selected properties. In this way, the next time the customer orders an item from the online store 104 of that type, the new values for the item's properties are used by the associate 120. For example, the server 106 may be programmed to automatically retrieve and display selected characteristics related to the customer and the selected item in response to the customer accessing the system 100 again through the computer 103. The server 106 may be programmed to automatically display available modifications to the selected characteristics related to the customer and the selected items. This may be done in a form of follow up questions presented by the server 106 to the display of the computer 103. The answers to the questions may then produce a signal and the server may be programmed to receive from the computer 103 a signal indicating selection of modification to the selected characteristics related to the selected item, and automatically store the modified selected characteristics related to the selected item in the database associating the characteristics with the particular customer and the selected item. The server may be programmed to automatically convert the modified selected characteristics related to the selected item to a modified selection scale, wherein the modified selection scale is different from the selection scale. Additionally, the server may be programmed to store the modified selection scale in the database associated with the particular user and the selected item.

Further still, the server 106 may be programmed to automatically adjust a scale of a second selected item by the user of the plurality of items for sale based processing the stored user selected characteristics and the stored modified selected characteristics for the user. The system of claim 16, wherein the server is further programmed to provide the modified selection scale for the particular user and the selected item for order filling.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the invention has been shown and described with reference to specific preferred embodiments, it should be understood by those skilled in the art that various changes in form and detail may be made therein without departing from the spirit and scope of the invention as defined by the following claims.

What is claimed is:

1. A system for online shopping for fresh food products, comprising:
a server comprising a memory, a database stored in the memory, and a processor, wherein the database contains data for a plurality of fresh food products; and
a computer coupled to the server wherein a user interfaces with the server through the computer, wherein the server is programmed to:
display available fresh food products from the data for the plurality of fresh food products on the computer coupled to the server;
receive from the computer a signal indicating selection of one of the available fresh food products;
automatically create and display a set of user selectable characteristics related to the selected fresh food product;
receive from the computer a signal indicating selection of characteristics related to the selected fresh food product;
automatically store the selected characteristics related to the selected fresh food product in the database associating the characteristics with the particular user and the selected fresh food product;
automatically convert the selected characteristics related to the selected fresh food product to a selection scale and store the selection scale in the database associated with the particular user and the selected fresh food product; and
provide the selection scale for the particular user and the selected fresh food product for order filling.

2. The system of claim 1, wherein the plurality of fresh food products comprises fruits.

3. The system of claim 1, wherein the plurality of fresh food products comprises vegetables.

4. The system of claim 1, wherein the plurality of fresh food products comprises fruits and vegetables.

5. The system of claim 1, wherein the selection scale is a numerical scale.

6. The system of claim 5, wherein the numerical scale is between 1 and 10, wherein 1 and 10 represent opposing extremes for each of the selected characteristics.

7. The system of claim 1, wherein the server is further programmed to:
automatically retrieve and display selected characteristics related to the user and the selected fresh food product; and
automatically display available modifications to the selected characteristics related to the user and the selected fresh food product.

8. The system of claim 7, wherein the server is further programmed to:
receive from the computer a signal indicating selection of modification to the selected characteristics related to the selected fresh food product; and
automatically store the modified selected characteristics related to the selected fresh food product in the database associating the characteristics with the particular user and the selected fresh food product.

9. The system of claim 8, wherein the server is further programmed to automatically convert the modified selected characteristics related to the selected fresh food product to a modified selection scale, wherein the modified selection scale is different from the selection scale, and store the modified selection scale in the database associated with the particular user and the selected fresh food product.

10. The system of claim 9, wherein the server is further programmed to provide the modified selection scale for the particular user and the selected fresh food product for order filling.

11. A method for shopping for fresh food products, comprising:
storing data for a plurality of fresh food products in a database of a server comprising a memory and a processor, wherein the database stored in the memory;
coupling the server to a computer wherein a user interfaces with the server through the computer;
displaying available fresh food products from the data for the plurality of fresh food products on the computer coupled to the server;
receiving at the server from the computer a signal indicating selection of one of the available fresh food products;
automatically creating at the server and display at the computer a set of user selectable characteristics related to the selected fresh food product;
receiving at the server from the computer a signal indicating selection of characteristics related to the selected fresh food product;
automatically storing the selected characteristics related to the selected fresh food product in the database associating the characteristics with the particular user and the selected fresh food product;
automatically converting by the server the selected characteristics related to the selected fresh food product to a selection scale and storing the selection scale in the database associated with the particular user and the selected fresh food product; and
providing the selection scale from the server for the particular user and the selected fresh food product for order filling.

12. The method of claim 11, further comprising:
automatically retrieving at the server and displaying at the computer, selected characteristics related to the user and the selected fresh food product; and
automatically displaying at the computer available modifications to the selected characteristics related to the user and the selected fresh food product.

13. The method of claim 12, further comprising:
receiving from the computer by the server a signal indicating selection of modification to the selected characteristics related to the selected fresh food product; and
automatically storing the modified selected characteristics related to the selected fresh food product in the database associating the characteristics with the particular user and the selected fresh food product.

14. The method of claim 13, further comprising automatically converting by the server the modified selected characteristics related to the selected fresh food product to a modified selection scale, wherein the modified selection scale is different from the selection scale, and store the modified selection scale in the database associated with the particular user and the selected fresh food product.

15. The method of claim 14, further comprising providing the modified selection scale by the server for the particular user and the selected fresh food product for order filling.

16. A system for online shopping for items, comprising:
a server comprising a memory, a database stored in the memory, and a processor, wherein the database contains data for a plurality of items for sale; and
a computer coupled to the server wherein a user interfaces with the server through the computer, wherein the server is programmed to:
display available items from the data for the plurality of items for sale on the computer coupled to the server;
receive from the computer a signal indicating selection of one of the available items;
automatically create and display a set of user selectable characteristics related to the selected item;
receive from the computer a signal indicating selection of characteristics related to the selected item;
automatically store the selected characteristics related to the selected item in the database associating the characteristics with the particular user and the selected fresh food product;
automatically convert the selected characteristics related to the selected item to a selection scale and store the selection scale in the database associated with the particular user and the selected item;
provide the selection scale for the particular user and the selected item for order filling;
automatically retrieve and display selected characteristics related to the user and the selected item in response to the user accessing the system again through the computer;
automatically display available modifications to the selected characteristics related to the user and the selected items;
receive from the computer a signal indicating selection of modification to the selected characteristics related to the selected item;
automatically store the modified selected characteristics related to the selected item in the database associating the characteristics with the particular user and the selected item;
automatically convert the modified selected characteristics related to the selected item to a modified selection scale, wherein the modified selection scale is different from the selection scale; and
store the modified selection scale in the database associated with the particular user and the selected item.

17. The system of claim 16, wherein the plurality of items for sale comprises items with subjective characteristics.

18. The system of claim 16, wherein the selection scale is a numerical scale.

19. The system of claim 16, wherein the server is further programmed to automatically adjust a scale of a second selected item by the user of the plurality of items for sale based processing the stored user selected characteristics and the stored modified selected characteristics for the user.

20. The system of claim 16, wherein the server is further programmed to provide the modified selection scale for the particular user and the selected item for order filling.
